(19) United States
(12) Patent Application Publication
(10) Pub. No.: US 2011/0200182 A1
(43) Pub. Date: Aug. 18, 2011

(54) CALL LOG CONSOLIDATION WITH ALTERNATE DIALING OPTIONS

(76) Inventors: JUSTIN Y. KODAMA, Mountain View, CA (US); SHADIA AHMED, San Francisco, CA (US); RICHARD DELLINGER, San Jose, CA (US); NATHAN S. STREU, San Francisco, CA (US)

(21) Appl. No.: 13/028,210

(22) Filed: Feb. 15, 2011

Related U.S. Application Data
(60) Provisional application No. 61/305,078, filed on Feb. 16, 2010.

(51) Int. Cl. H04M 3/42

(52) U.S. Cl. 379/201.04

(57) ABSTRACT

A system (and method) is disclosed for consolidating communication details associated with a data object in a call log. The system receives communication information corresponding to a contact record and determines whether a call log includes a previously stored data object having the communication information and associated with the contact record. The system associates the received communication information with the previously stored data object having the communication information in response to existence of the previously stored data object. Otherwise, the system creates for inclusion with the call log a new data object having the received communication information a new data object in response to no previously stored data object having the communication information. The previously stored or new data object is displayed in the call log.

### CROSS REFERENCE TO RELATED APPLICATIONS

This application claims the benefit of U.S. Provisional Application No. 61/305,078, filed Feb. 16, 2010, which is incorporated by reference in its entirety.

### BACKGROUND

1. Field of Art

The disclosure generally relates to the field of call log consolidation and alternate dialing options.

2. Description of Art

Telephone call lists are known. Most conventional call lists are configured to provide a serial listing of incoming calls in reverse chronological order with the most recently received call listed first. Other conventional call lists are configured to provide a serial listing of incoming and outgoing calls. Again, this list is commonly provided in reverse chronological order with the most recently received or placed call listed first.

One problem with conventional call lists is that they typically are limited to phone calls. As modes of communication increase other forms of communication often are not accounted for in call lists. Another problem with conventional call lists is that information on calls received or placed cannot be organized beyond a chronological order. Still another problem with conventional call lists is that they provide only the dialed telephone number from where the call was received or to where the call was placed.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1a illustrates one embodiment of a mobile computing device in a first positional state.

FIG. 1b illustrates one embodiment of the mobile computing device in a second positional state.

FIG. 2 illustrates one embodiment of an architecture of a mobile computing device.

FIG. 3 illustrates one embodiment of a call log module.

FIG. 4 illustrates one embodiment for data object engine for a call log module.

FIGS. 5a through 5c illustrate example call log user interfaces.

FIG. 6 illustrates one embodiment of an example process summarizing operation of the call log module.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A system (and method and computer readable storage medium) is configured to consolidate communication details associated with a data object in a call log. The system receives new communication information corresponding to communications with a contact. The system determines whether a previously stored data object has previously stored communication information corresponding with the new communication information that is present within a call log. If there is no presence of the previously stored data object having the previously stored communication information corresponding to the new communication information, the system stores the new communication information as a new data object in the call log.

If there is a presence of the previously stored data object having the previously stored communication information corresponding to the new communication information, the system associates and stores the new communication information with the previously stored data object in the call log. If the previously stored data object having the previously stored communication information corresponding to the new communication information, the system displays in the call log the previously stored data object with both new communication information and the previously stored communication information in a predetermined format. In one embodiment the predetermined format comprises grouping communication information of a same type.

In addition, in one embodiment information of the contact is previously stored in a contact database. The contract data object includes a current contact information corresponding the new communication information and an alternate contact information. The system retrieves from a contact database the alternate contact information for the contact in the contact database and displays the alternate contact information with the previously stored data object or with the newly stored data object.

### Example Mobile Computing Device

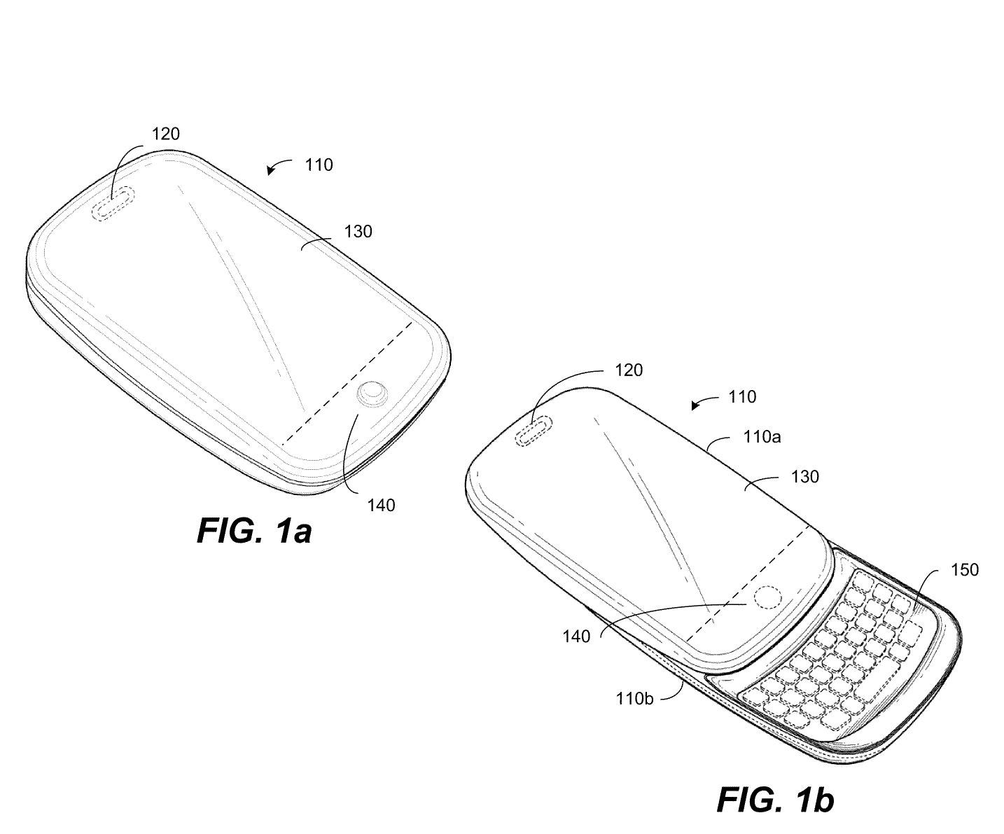

In one example embodiment, the configuration as disclosed may be configured for use between a mobile computing device, that may be host device, and an accessory device. FIGS. 1a and 1b illustrate one embodiment of a mobile computing device 110. FIG. 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, smartphone, netbook, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. Likewise, the mobile computing device 110 is only by way of example, and the principles of its functionality apply to other computing devices, e.g., desktop computers, server computers and the like.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

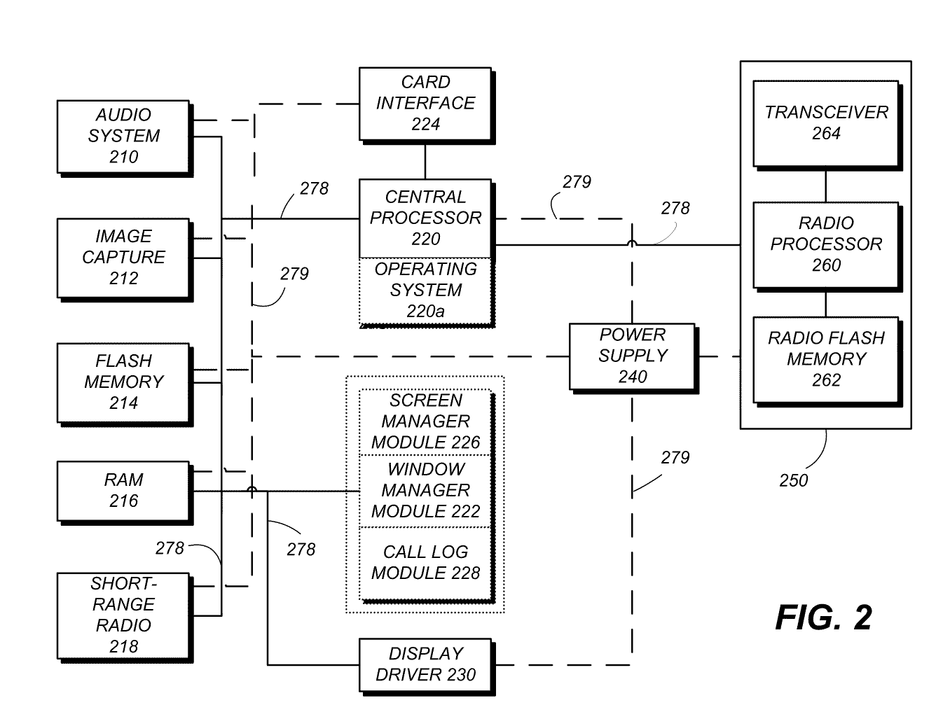

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIGS. 1a and 1b. The mobile computing device 110 includes a central processor 220, a power supply 240, and a radio subsystem 250. Examples of a central processor 220 include processing chips and system based on architectures such as ARM (including cores made by microprocessor manufacturers), ARM XSCALE, AMD ATHLON, SEMPRON or PHENOM, INTEL XSCALE, CELERON, CORE, PENTIUM or ITANIUM, IBM CELL, POWER ARCHITECTURE, SUN SPARC and the like.

The central processor 220 is configured for operation with a computer operating system. The operating system is an interface between hardware and an application, with which a user typically interfaces. The operating system is responsible for the management and coordination of activities and the sharing of resources of the mobile computing device 110. The operating system provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279.

The central processor communicates with applications executing within the mobile computing device 110 through the operating system 220a. In addition, intermediary components, for example, a window manager module 222 and a screen manager module 226, provide additional communication channels between the central processor 220 and operating system 220 and system components, for example, the display driver 230.

In one embodiment, the window manager module 222 comprises a software (e.g., integrated with the operating system) or firmware (lower level code that resides is a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

A call log module 228 comprises software that is, for example, integrated with the operating system or configured to be an application operational with the operating system. In some embodiments it may comprise firmware, for example, stored in the flash memory 214. The call log module 228 is configured to receive information on incoming and outgoing communications, e.g., through a voice channel, and store and display that information within a user interface displayed on the screen 130. Examples of incoming and outgoing communications through a voice channel include telephone calls, short message service (SMS) message, and multimedia service (MMS) messages. The information that is received is communications information, e.g., a telephone number corresponding to the received or placed communication and a name associated with that telephone number. In addition, the call log module 228 is configured to interface with a contact database to determine whether the communication information has a corresponding entry in the contact database. If there is a corresponding entry, e.g., contact name and corresponding contact information including additional contact details, the call log module 228 either provides a link to the stored contact or retrieves the additional contact information to display in the call log as is further described herein.

It is noted that in one embodiment, central processor 220 executes logic (e.g., by way of programming, code, or instructions) corresponding to executing applications interfaced through, for example, the navigation area 140 or switches 170. It is noted that numerous other components and variations are possible for the hardware architecture of the computing device 200, thus an embodiment such as shown by FIG. 2 is just illustrative of one implementation for an embodiment.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

### Call Log Module Configuration

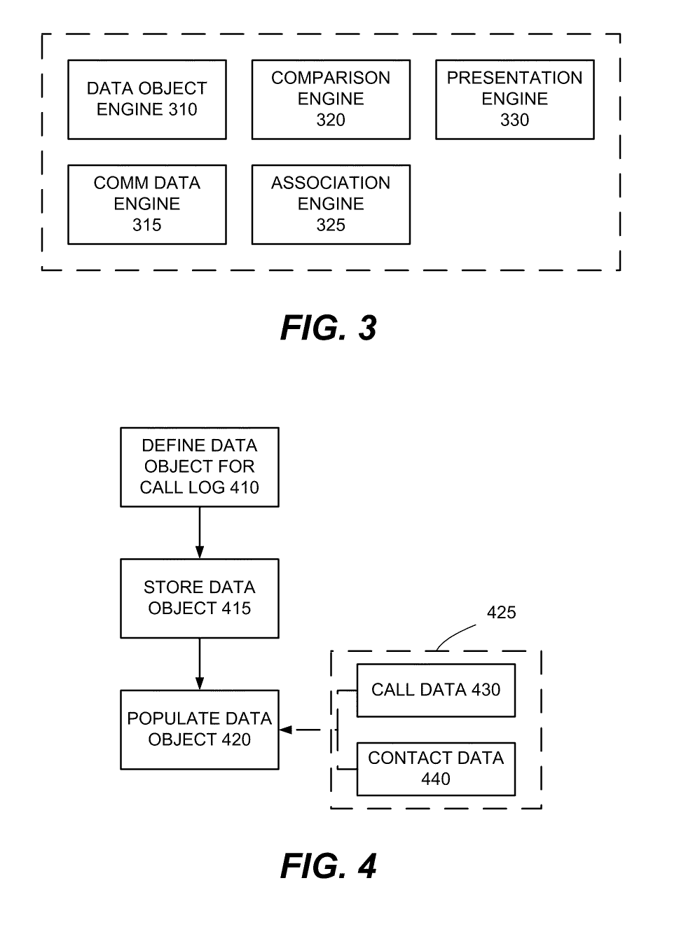

Turning now to FIG. 3, it illustrates one embodiment of a call log module 228. The call log module 228 includes a data object engine 310, communication (comm) data engine 315, a comparison engine 320, an association engine 325, and a presentation engine 330. Each engine may be configured as a software component or sub-module having functional features that are embodied as instructions stored on a storage medium, e.g., the flash memory 214 and/or the RAM 216, and executable by a processor, e.g., the processor 220.

The data object engine 310 can be integrated with the call log module 228 or may be separate from the call log module 228. When the data object engine 320 is separate from the call log module 228 there is included a data object engine interface in the call log module 228. The data object engine 310 is configured to generate a data object. The data object provides a structure within which data retrieved from various sources is organized and then used to present within a user interface displayed on the screen 130.

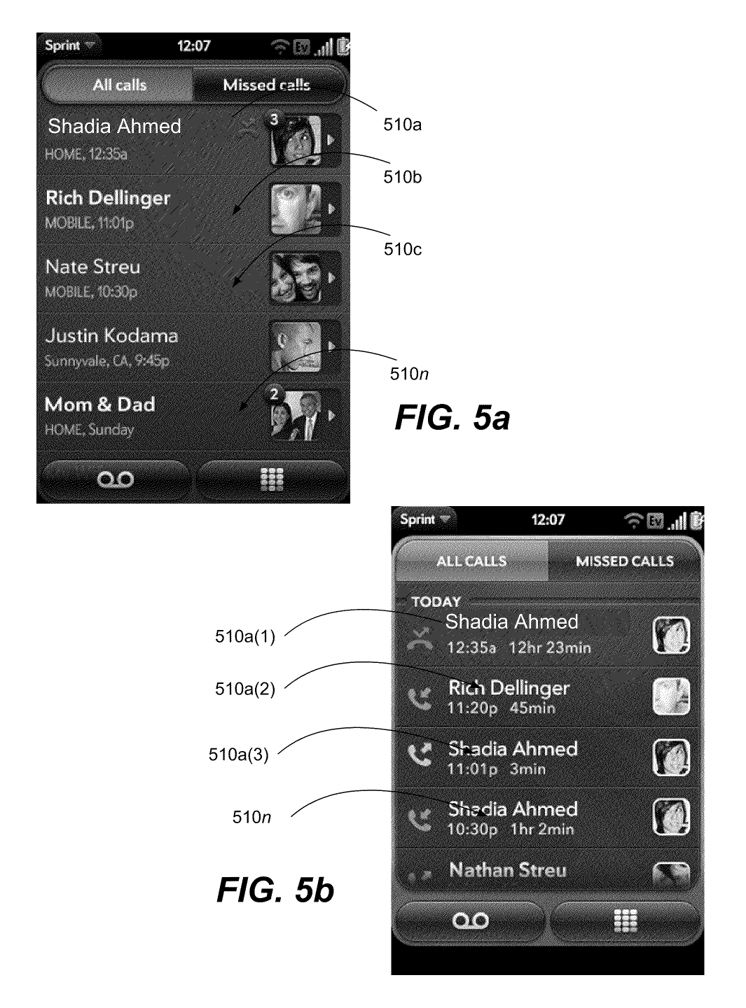

Referring briefly to FIG. 4, it illustrates one embodiment for data object engine 310 for a call log module 228. The data object engine 310 defines 410 a data object for the call log module 228. The definition corresponds to a structure for the data object, including, for example, what type of data will populate it, where will the data be retrieved from, what is the format for that data, and what is the format to present the data. The data object engine 310 stores 415 the data object once it is created. Once created, each instance of data to be presented through the call log module creates a record based on the stored 415 data object. The record is created by populating 420 a data object with data from a data source 425. For example, the data source can be a call data 430 or contact data 440. The call data 430 includes communication information corresponding to incoming and outgoing communications, for example, through a voice channel. The contact data 440 includes contact information corresponding to a contact record in a contact database. The contact record includes, for example, an individual or an organization name. The contract information includes, for example, one or more telephone numbers, an email address, an instant messenger address, mailing address, or the like.

Referring back to FIG. 3, the communication data engine 315 is configured to receive data corresponding to communications to or from the mobile computing device 110. For example, the communication data engine 315 is configured to interface with the processing subsystem (processor 220 and operating system 220a) and/or the radio subsystem 250 to gather communication information associated with a phone application or a messaging application. The communication information corresponds to incoming or outgoing communications through a voice channel and includes, for example, a telephone number or messaging number from which a communication (e.g., a call or message) is received or to which a communication is transmitted.

The comparison engine 320 is configured to compare the communication information data from the communication data engine 315 to previously stored data objects in the call log module 228 as well as with other data sources. For example, the comparison engine 320 is configured to determine if there is a data object previously stored within the call log module 228 having the same or all of the current (or newly received) communication information. The comparison engine also is configured to compare the communication information data with contact data stored in a contact database. The comparison logic can be structured to provide (or allow for) different levels of granularity, for example, an exact match, a partial match, or a an exact match for some data and a partial match for other data.

The association engine 325 includes logic to act upon the results of the comparison engine 320. If the communication information data from the communication data engine 315 has matched, as determined by the comparison engine 320, the association engine 325 determines what to do with that match. For example, the association engine 325 can be configured to group within a single data object the communication information for a particular communication entity. Thus, if there is already a data object for the communication entity, e.g., identified by name, telephone number or messaging number, the association engine 325 would associate new communication information with the previously stored data object for the communication entity rather than create a new data object for that communication entity. Hence, the call log is beneficially streamlined and provides a higher level of abstractions corresponding to a particular communication entity rather than just a chronological listing.

The association engine 325 logic also can be structured to retrieve additional data corresponding to the communication entity. For example, the communication entity can be compared against a record in a database, e.g., a contact database, to determine if a match exists. If a match is determined to exist, the association engine 325 can be configured to retrieve the additional data from the matched record for integration with the data object in the call log module 228. Alternately, when there is a match the association engine 325 logic can be structured to provide a link to the record in the database within the data object of the call log module 228.

The presentation engine 330 also is configured to provide a user interface for the call log module 228. The user interface, further described and illustrated below, is configured to include an interface to present the data object (and corresponding data) from the data object engine 310. The user interface of the call log module 228 is configured to include logic for display on a screen 130 of the mobile computing device 110 and can be configured to interoperate with the screen manager module 222 and the window manager module 226.

### Call Log Module User Interface

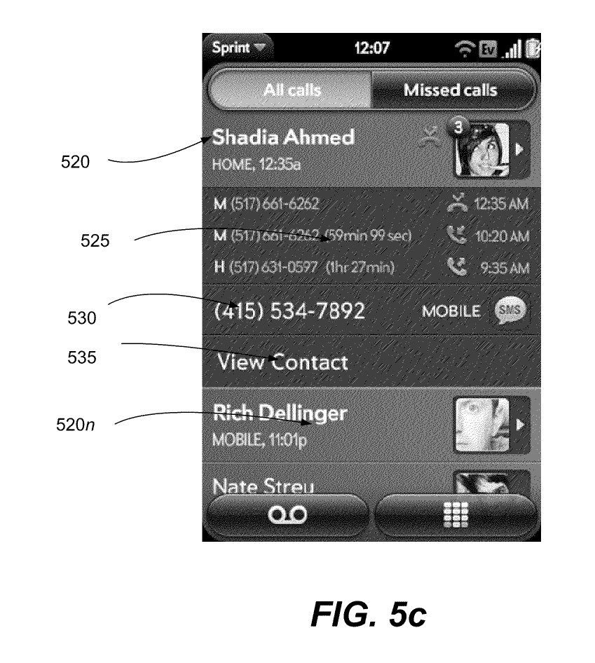

FIGS. 5a through 5c illustrate example call log user interfaces. FIG. 5a illustrates a call log user interface in which each entry, e.g. 510a, 510b, . . . 510n (n corresponding to an integer) (generally 510), is a data object that corresponds to a separate communication entity. In this example user interface the communication entity for the data object is a person, for which a name is associated (e.g., Shadia Ahmed, Rich Dellinger, Nate Streu, etc.) or an entity is associated (e.g., Mom & Dad). For ease of reference, each communication entity in these examples will be referenced as a “name”. The name can be a name that is associated with a telephone number through either a remote service, e.g., caller identification, or a local service, e.g., a contact database.

FIG. 5b illustrates another example of a user interface for the call log module 228. In this example, a data object 510 has been created for each instance of a communication with a communication entity (e.g., person). Also shown is a grouping of associated data objects based on name. In addition, each data object includes an icon corresponding to whether a call was outgoing (arrow away from illustrated handset), incoming (arrow towards illustrated handset) or missed (arrow “bouncing” off of illustrated handset).

FIG. 5c illustrates an example user interface for the call log module 228 in which the call log module uses a single instance of a data object for a communication entity. An example of a communication entity is a person, a corporation, an association or the like. When communication is first established with the user the call log module 228 generates a data object and stores that data object as a record. The data object record is stored using the name of the communication entity. In this example, the communication entity is a person with a name Shadia Ahmed. A data object record 520 is created and stored under this name. In this example, once the data object is created, additional details are also assembled within the data object. Specifically, the call log module 228 through its communications data engine 315, comparison engine 320, and association engine 325, determines that a local service, e.g., the contact database, has contact details for Lando Carlrissian, including a picture. These additional data elements are retrieved from the contact database and copied into the data object for subsequent display in the user interface.

After the data object is created, for example, when an initial call was made to Shadia Ahmed at 9:35 AM to the home number, the call log module 228 through its communications data engine 315, comparison engine 320, and association engine 325 determines that a contact record exists for Shadia Ahmed and associates that contact record with the call log module object. Accordingly, subsequent calls to and from Shadia Ahmed 525 are associated with this data object 520 and activity associated with Shadia Ahmed (e.g., calls to and from on mobile phone or home phone) and all assembled within a single data object record rather than scattered throughout the call log. A number by the picture indicates the number of communications with Lando Carlrissian that are consolidated with this particular data object record.

It is noted that the data objects of the call log module 228 are configured to be active elements. That is, entries having communication information such as a telephone number or messaging number is selectable. Once selected, the call log module 228 communicates with the appropriate application, e.g., a phone application or messaging application, and provides the appropriate number to that application. The application continues with the communication process using the telephone number or messaging number provided by the call log module 228. In addition, it also is noted that the call log module 228 may be integrated with the phone application and/or messaging application.

Also illustrated through FIG. 5c is the alternate contact option to contact Shadia Ahmed as described with the association engine 325. In particular, the example user interface includes additional data that has been retrieved, for example, from a contact database entry for Shadia Ahmed, and is now associated with the data object, for example, another (or alternate) mobile telephone contact number 530. In embodiments in which the call log module 228 includes selectable active elements and is integrated with the phone application, this contact number provides an alternate dialing option for the phone application. If the call log module 228 is integrated with the messaging application, alternate texting options may be available (e.g., text number or messaging service identifiers) for text type messaging (e.g., SMS, MMS). In addition, the user interface of the call log module 228 in this example provides an active element that links 535 to the local service, e.g., contact database, having more details about the contact.

It is noted that the data object can be continually maintained as a single record for multiple days when communication occurs with a particular contact or that a new data object can be created for each day when communication occurs with a particular contact. For a single record/multiple days configuration, communications on subsequent days are included within a one data object. For a single record/each day configuration, there is one data object created and maintained for Shadia Ahmed for each day. In this latter scenario, on February 1 a first data object having the name Shadia Ahmed is created and maintained in the call log module 228 for all communications on that day. Thereafter, on February 2 (a second (separate) day) a new (e.g., second) data object named Shadia Ahmed is created and maintained in the call log module 228 under which all communications on that day are consolidated.

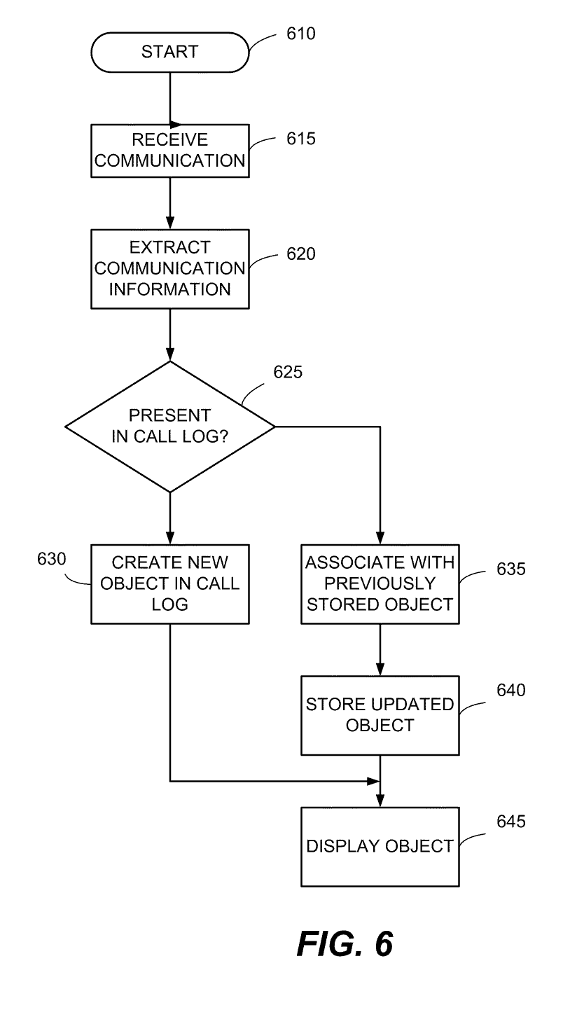

FIG. 6 illustrates one embodiment of an example process summarizing operation of the call log module 228. The process starts 610 and receives notification of a communication, e.g., a dialed call or received call. The communication data engine 315 retrieves (or extracts) 615 out the communication information, e.g., the dialed or received call and caller identification, if available. The comparison engine 320 determines 625 if there is a previously stored data object in the call log associated with the particular communication information. If there is no data object in the call log module 228 for this particular contact information, a new data object is generated (or created) 630 for it.

If there already is a data object in the call log module 228 for the communication information, the association engine 325 associates 635 the current (or new) communication information with the previously stored data object. The updated data object is stored 640 with the call log module 228. In addition, either the newly created data object or the updated data object can be displayed 645 by the user interface of the call log module, for example, as illustrated in FIG. 5c.

It is noted that the example process may include additional steps depending on how the information is to be stored and provided for display in the user interface of the call log module 228. For example, the example process may allow for determining whether a data object has been created for a particular day. Alternately, the data objects may be configured based on other information related to the communication information. For example, there may be one data object for contacts designated business or work contacts, one for personal contacts, and one for family contacts. In such configurations, a local service, e.g., the contact database would be used to classify particular contacts and that classification would be used by the call log module 228 data object to organize the caller details in the call log module.

The disclosed embodiments beneficially increase the flexibility and use of call logs, including call lists. The call log as disclosed allows for organizing communications beyond temporal organization so that additional context and information is associated with particular communications and entities. In addition, the disclosed configurations beneficially allow for interaction with other services, e.g., a contact database, to provide additional available paths for communication without having to switch applications. This increases ease of use and enhances user experiences with call logs.

### Additional Configuration Considerations

Some portions of above description describe the embodiments in terms of algorithms and symbolic representations of operations on information, for example, as illustrated and described with respect to FIGS. 2, 3, 4, 5, and 6. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for call log consolidation and providing alternate communication (e.g., dialing or texting) details with a call log through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for consolidating communication details associated with a data object in a call log, the method comprising:
receiving, by a computer system, communication information corresponding to a contact record;
determining whether a call log includes a previously stored data object having the communication information and associated with the contact record;
associating the received communication information with the previously stored data object having the communication information in response to existence of the previously stored data object;
creating, for inclusion with the call log, a new data object having the received communication information a new data object in response to non-existence of the previously stored data object having the communication information; and
displaying the at least one of the previously stored data object and the new data object in the call log.

2. The method of claim 1, wherein displaying the data object in the call log further comprises grouping communication information of a same type.

3. The method of claim 1, wherein the contact record is stored in a contact database.

4. The method of claim 1, wherein the contact record includes current contact information corresponding the received communication information and an alternate contact information.

5. The method of claim 4, further comprising:
retrieving from a contact database the alternate contact information for the contact record in the contact database; and
displaying the alternate contact information with the previously stored data object.

6. The method of claim 4, further comprising:
retrieving from a contact database the alternate contact information for the contact record in the contact database; and
displaying the alternate contact information with the new data object.

7. A non-transitory computer readable storage medium storing instructions for consolidating communication details associated with a data object in a call log, the instructions when executed causes at least one processor to:
receive communication information corresponding to a contact record;
determine whether a call log includes a previously stored data object having the communication information and associated with the contact record;
associate the received communication information with the previously stored data object having the communication information in response to existence of the previously stored data object;
create, for inclusion with the call log, a new data object having the received communication information a new data object in response to non-existence of the previously stored data object having the communication information; and
display the at least one of the previously stored data object and the new data object in the call log.

8. The computer readable storage medium of claim 7, wherein displaying the data object in the call log further comprises grouping communication information of a same type.

9. The computer readable storage medium of claim 7, wherein the contact record is stored in a contact database.

10. The computer readable storage medium of claim 7, wherein the contact record includes current contact information corresponding the received communication information and an alternate contact information.

11. The computer readable storage medium of claim 10, further comprising instructions that cause the at least one processor to:
retrieve from a contact database the alternate contact information for the contact record in the contact database; and
display the alternate contact information with the previously stored data object.

12. The method of claim 4, further comprising instructions that cause the at least one processor to:
retrieve from a contact database the alternate contact information for the contact record in the contact database; and
display the alternate contact information with the new data object.

13. A method for consolidating communication details associated with a data object in a call log, the method comprising:
receiving a new communication having communication information including information about the sender;
determining whether a data object corresponding to the sender exists in association with a call log;
determining, in response to existence of the data object, whether the data object includes communication information from a prior communication with the sender;
storing communication information from the new communication with the data object in response to existence of the data object;
creating a new data object corresponding to the client for association with the call log in response to non-existence of the data objection; and
storing the communication information from the new communication in the new data object.

14. The method of claim 13, further comprising displaying in the call log the data object having the communication information including information about the sender.

15. The method of claim 14, wherein the predetermined format comprises grouping communication information of a same type.

16. The method of claim 13, wherein information corresponding to the sender are stored in a contact database.

17. The method of claim 16, wherein information corresponding to the sender in the contact database populates a contract data object, the contact data object including a current contact information corresponding the received communication information and an alternate contact information.

18. The method of claim 17, further comprising:
retrieving from a contact database the alternate contact information for the contact in the contact database; and
displaying the alternate contact information with the existing data object.

19. The method of claim 17, further comprising:
retrieving from a contact database the alternate contact information for the contact in the contact database; and
displaying the alternate contact information with the new data object.

20. A non-transitory computer readable storage medium configured to store instructions to consolidate communication details associated with a data object in a call log, the instructions when executed by at least one processor cause the at least one processor to:
receive a new communication having communication information including information about the sender;
determine whether a data object corresponding to the sender exists in association with a call log;
determine, in response to existence of the data object, whether the data object includes communication information from a prior communication with the sender;
store communication information from the new communication with the data object in response to existence of the data object;
create a new data object corresponding to the client for association with the call log in response to non-existence of the data objection; and
store the communication information from the new communication in the new data object.

21. The computer readable storage medium of claim 20, further comprising displaying in the call log the data object having the communication information including information about the sender.

22. The computer readable storage medium of claim 21, wherein the predetermined format comprises grouping communication information of a same type.

23. The computer readable storage medium of claim 20, wherein information corresponding to the sender are stored in a contact database.

24. The computer readable storage medium of claim 23, wherein information corresponding to the sender in the contact database populates a contract data object, the contact data object including a current contact information corresponding the received communication information and an alternate contact information.

25. The computer readable storage medium of claim 24, further comprising instructions that cause the at least one processor to:
retrieve from a contact database the alternate contact information for the contact in the contact database; and
display the alternate contact information with the existing data object.

26. The computer readable storage medium of claim 24, further comprising instructions that cause the at least one processor to:
retrieving from a contact database the alternate contact information for the contact in the contact database; and
displaying the alternate contact information with the new data object.
